(19) United States
(12) Patent Application Publication
(10) Pub. No.: US 2022/0206327 A1
(43) Pub. Date: Jun. 30, 2022

(54) SELF-CAPACITIVE TOUCH DISPLAY PANEL, DRIVING METHOD THEREOF, AND DISPLAY DEVICE

(71) Applicant: Shenzhen China Star Optoelectronics Semiconduct Display Technology Co., Ltd., Shenzhen, Guangdong (CN)

(72) Inventors: Liwei GONG, Shenzhen, Guangdong (CN); Woosuk HA, Shenzhen, Guangdong (CN); Yunglun LIN, Shenzhen, Guangdong (CN); Mingjong JOU, Shenzhen, Guangdong (CN)

(21) Appl. No.: 17/051,455

(22) PCT Filed: Apr. 28, 2020
(86) PCT No.: PCT/CN2020/087528

§ 371 Date: Oct. 29, 2020

(30) Foreign Application Priority Data
Apr. 16, 2020 (CN) 202010298749.4

(51) Int. Cl. G02F 1/1333; G02F 1/1368; G06F 3/044; G06F 3/041

(52) U.S. Cl. CPC G02F 1/13338; G02F 1/1368; G02F 1/136209; G06F 3/044; G06F 3/04184; G02F 1/13685

(57) ABSTRACT

A self-capacitive touch display panel, a driving method thereof, and a display device are provided. The self-capacitive touch display panel includes a first substrate including a first base, a touch electrode layer, a driving circuit layer, and a pixel electrode layer, wherein the touch electrode layer is disposed between the first base and the driving circuit layer; a second substrate; and a liquid crystal layer. It realizes integration of a vertically-oriented display panel and a self-capacitive touch scheme, which saves costs, has high sensitivity, and is more suitable for large-sized commercial products.

### FIELD OF INVENTION

The present application relates to the field of display, and in particular, to a self-capacitive touch display panel, a driving method thereof, and a display device.

### BACKGROUND OF INVENTION

As a type of biometric technology, fingerprint recognition technology has characteristics of universality, uniqueness, security, and collectability, and has been widely used in smart phones and other products along with a rise of full-screen technology.

However, most current touch displays are externally mounted, that is, a touch panel is attached to display panels. This method will increase a thickness of screens and terminal devices, increasing process and cost of modules, and affecting user experience.

Therefore, the current touch displays have defects and need to be improved.

### SUMMARY OF INVENTION

### Technical Problem

The present application provides a self-capacitive touch display panel, a driving method thereof, and a display device to improve defects existing in current touch displays.

### Technical Solutions

The present application provides a self-capacitive touch display panel, including:

a first substrate including a first base, a touch electrode layer, a driving circuit layer, and a pixel electrode layer, wherein the touch electrode layer is disposed on a side of the first base near the driving circuit layer, the driving circuit layer is disposed on a side of the touch electrode layer away from the first base, and the pixel electrode layer is disposed on a side of the driving circuit layer away from the first base;

a second substrate disposed opposite to the first substrate, and including a second base and a common electrode layer; and

a liquid crystal layer filled between the first substrate and the second substrate.

In the self-capacitive touch display panel according to present application, the self-capacitive touch display panel further including a thin film transistor formed in the driving circuit layer, wherein the touch electrode layer includes a touch electrode, and a projection of the thin film transistor on the first base at least partially overlaps a projection of the touch electrode on the first base.

In the self-capacitive touch display panel according to present application, the self-capacitive touch display panel further including a thin film transistor formed in the driving circuit layer, wherein the touch electrode layer includes a touch electrode, and a projection of the thin film transistor on the first base does not overlap a projection of the touch electrode on the first base.

In the self-capacitive touch display panel according to present application, the first substrate further includes a black matrix layer, the black matrix layer is disposed on a side of the first base near the touch electrode layer and is in contact with the first base, and the second substrate further includes a color resist layer.

In the self-capacitive touch display panel according to present application, the first substrate further includes a color resist layer, the color resist layer is disposed on a side of the pixel electrode layer near the first base and is in contact with the pixel electrode layer, and the second substrate further includes a black matrix layer.

In the self-capacitive touch display panel according to present application, the first substrate further includes a black matrix layer and a color resist layer, the black matrix layer is disposed on a side of the first base near the touch electrode layer and is in contact with the first base, and the color resist layer is disposed on a side of the pixel electrode layer near the first base and is in contact with the pixel electrode layer.

In the self-capacitive touch display panel according to present application, the touch electrode layer includes a touch electrode terminal and a touch electrode, and the touch electrode terminal is connected to the touch electrode.

In the self-capacitive touch display panel according to present application, the touch electrode terminal and the touch electrode are integrally formed, and the touch electrode has a grid structure.

In the self-capacitive touch display panel according to present application, the touch electrode terminal and the touch electrode are formed separately, and the touch electrode includes a planar film structure.

In the self-capacitive touch display panel according to present application, the first substrate further includes a shielding layer, and the shielding layer is disposed between the touch electrode layer and the driving circuit layer.

The present application also provides a display device including a self-capacitive touch display panel, and the self-capacitive touch display panel including:

a first substrate including a first base, a touch electrode layer, a driving circuit layer, and a pixel electrode layer, wherein the touch electrode layer is disposed on a side of the first base near the driving circuit layer, the driving circuit layer is disposed on a side of the touch electrode layer away from the first base, and the pixel electrode layer is disposed on a side of the driving circuit layer away from the first base;

a second substrate disposed opposite to the first substrate, and including a second base and a common electrode layer; and

a liquid crystal layer filled between the first substrate and the second substrate.

In the display device according to present application, the display device further including a thin film transistor formed in the driving circuit layer, wherein the touch electrode layer includes a touch electrode, and a projection of the thin film transistor on the first base at least partially overlaps a projection of the touch electrode on the first base.

In the display device according to present application, the display device further including a thin film transistor formed in the driving circuit layer, wherein the touch electrode layer includes a touch electrode, and a projection of the thin film transistor on the first base does not overlap a projection of the touch electrode on the first base.

In the display device according to present application, the first substrate further includes a black matrix layer, the black matrix layer is disposed on a side of the first base near the touch electrode layer and is in contact with the first base, and the second substrate further includes a color resist layer.

In the display device according to present application, the first substrate further includes a color resist layer, the color resist layer is disposed on a side of the pixel electrode layer near the first base and is in contact with the pixel electrode layer, and the second substrate further includes a black matrix layer.

In the display device according to present application, the first substrate further includes a black matrix layer and a color resist layer, the black matrix layer is disposed on a side of the first base near the touch electrode layer and is in contact with the first base, and the color resist layer is disposed on a side of the pixel electrode layer near the first base and is in contact with the pixel electrode layer.

In the display device according to present application, the touch electrode layer includes a touch electrode terminal and a touch electrode, and the touch electrode terminal is connected to the touch electrode.

In the display device according to present application, the touch electrode terminal and the touch electrode are integrally formed, and the touch electrode has a grid structure.

In the display device according to present application, the first substrate further includes a shielding layer, and the shielding layer is disposed between the touch electrode layer and the driving circuit layer.

Meanwhile, the present application provides a driving method of a self-capacitive touch display panel for driving the self-capacitive touch display panel as described above, the method including:

when a display driving signal is input to the self-capacitance touch display panel, stopping inputting a touch driving signal; and

when the self-capacitive touch display panel stops inputting the display driving signal, the touch driving signal is input.

### Beneficial Effect

Embodiments of the present application provide a self-capacitive touch display panel, a driving method thereof, and a display device. The self-capacitive touch display panel includes a first substrate including a first base, a touch electrode layer, a driving circuit layer, and a pixel electrode layer, wherein the touch electrode layer is disposed on a side of the first base near the driving circuit layer, the driving circuit layer is disposed on a side of the touch electrode layer away from the first base, and the pixel electrode layer is disposed on a side of the driving circuit layer away from the first base; a second substrate disposed opposite to the first substrate, including a second base and a common electrode layer; and a liquid crystal layer filled between the first substrate and the second substrate. The display panel realizes integration of touch display by providing the touch electrode layer in the first substrate, and realizes integration of a vertically-oriented display panel and a self-capacitive touch scheme. There are almost no increase to thickness and weight of the self-capacitive touch display panel, while a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

### BRIEF DESCRIPTION OF FIGURES

The following detailed description of specific embodiments of the present application will make the technical solutions and other beneficial effects of the present application obvious in conjunction with the accompanying drawings.

FIG. 1 is a schematic diagram of a first structure of a self-capacitive touch display panel according to an embodiment of the present application.

FIG. 2 is a schematic diagram of a second structure of the self-capacitive touch display panel according to an embodiment of the present application.

FIG. 3 is a schematic diagram of a third structure of the self-capacitive touch display panel according to an embodiment of the present application.

FIG. 4 is a schematic diagram of a fourth structure of the self-capacitive touch display panel according to an embodiment of the present application.

FIG. 5 is a schematic diagram of a fifth structure of the self-capacitive touch display panel according to an embodiment of the present application.

FIG. 6 is a schematic diagram of a sixth structure of the self-capacitive touch display panel according to an embodiment of the present application.

FIG. 7 is a schematic diagram of a seventh structure of the self-capacitive touch display panel according to an embodiment of the present application.

FIG. 8 is a schematic diagram of an eighth structure of the self-capacitive touch display panel according to an embodiment of the present application.

FIG. 9 is a flowchart of a driving method of a self-capacitive touch display panel according to an embodiment of the present application.

FIG. 10 is a driving timing diagram of a self-capacitive touch display panel according to an embodiment of the present application.

### DETAILED DESCRIPTION OF EMBODIMENTS

The present application provides a self-capacitive touch display panel to alleviate problem of defects in conventional touch displays.

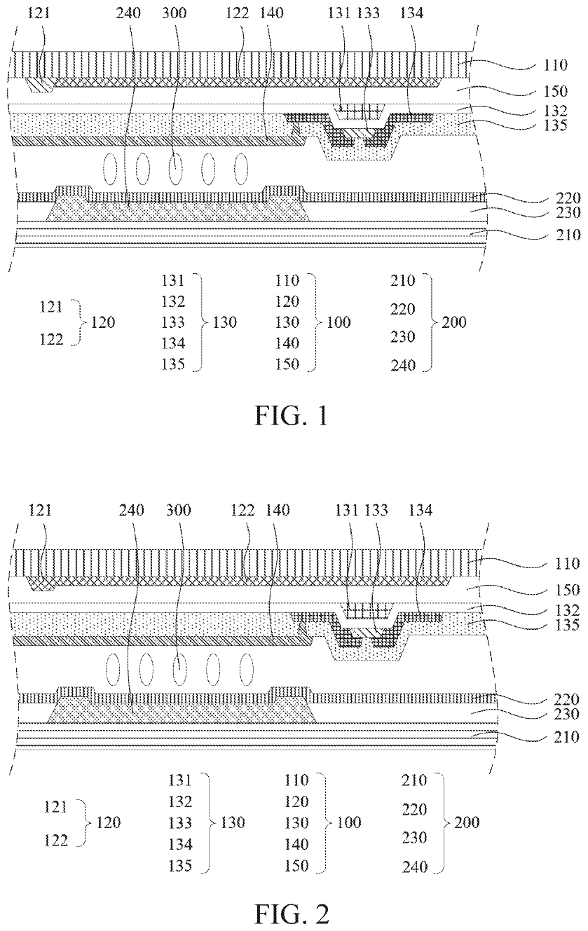

As shown in FIG. 1 to FIG. 8, the self-capacitive touch display panel provided in the present application includes as follows.

A first substrate 100 includes a first base 110, a touch electrode layer 120, a driving circuit layer 130, and a pixel electrode layer 140. The touch electrode layer 140 is disposed on a side of the first base 110 near the driving circuit layer 130, the driving circuit layer 130 is disposed on a side of the touch electrode layer 120 away from the first base 110, and the pixel electrode layer 140 is disposed on a side of the driving circuit layer 130 away from the first base 110.

A second substrate 200 is disposed opposite to the first substrate 100, and includes a second base 210 and a common electrode layer 220.

A liquid crystal layer 300 is filled between the first substrate 100 and the second substrate 200.

The present embodiment provides a self-capacitive touch display panel, wherein the display panel realizes integration of touch display by providing the touch electrode layer in the first substrate, and realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

In an embodiment of the present application, each self-capacitive touch display panel is a top emission mode, that is, as shown in FIGS. 1 to 8, the first substrate is a light-outputting surface substrate, and the second substrate is a light-incident surface substrate.

In a first embodiment, please refer to FIG. 1, where FIG. 1 is a schematic diagram of a first structure of the self-capacitive touch display panel according to an embodiment of the present application. The self-capacitive touch display panel provided in the present embodiment includes as follows.

A first substrate 100 includes a first base 110, a touch electrode layer 120, a driving circuit layer 130, a pixel electrode layer 140, and an insulating layer 150. The touch electrode layer 120 is disposed under the first base 110, and is bonded to the first base 110. The driving circuit layer 130 is disposed under the touch electrode layer 120, and is separated from the touch electrode layer 120 by the insulating layer 150. The pixel electrode layer 140 is disposed under the driving circuit layer 130, and is electrically connected to the driving circuit layer 130 through a hole.

The first base 110 is a transparent base, and is generally a transparent rigid glass base or a transparent flexible base. The transparent flexible base generally includes a first organic base, a second organic base, and an inorganic base between the first organic base and the second organic base. Materials of the first organic base and the second organic base are usually organic polymer materials such as polyacetamide and polyethylene terephthalate. Material of the inorganic base is generally silicon oxide, which is used to block external particles from entering the substrate and to isolate water and oxygen.

The touch electrode layer 120 includes a touch electrode terminal 121 and a touch electrode 122. The touch electrode terminal 121 is electrically connected to the touch electrode 122. The touch electrode terminal 121 and the touch electrode 122 are formed separately, that is, the touch terminal 121 and the touch electrode 122 are not fabricated by a same process. The touch electrode terminal 121 is generally a metal conductive wire. Material of the metal conductive wire can be metal molybdenum, aluminum, copper, titanium, chromium, or silver, or a combination thereof. The metal conductive wire can be a single-film layer structure, such as single-layer metal copper, single-layer metal aluminum, or single-layer metal copper, etc.; it can be a double-layer structure, such as aluminum/molybdenum laminated structure, aluminum/titanium laminated structure, or copper/titanium laminated structure; it can also be a three-layer structure, such as molybdenum/aluminum/molybdenum laminated structure, titanium/aluminum/titanium laminated structure, or titanium/copper/titanium laminated structure, etc., which are not particularly limited herein. The touch electrode 122 is a transparent conductive film, and material of the touch electrode 122 includes indium tin oxide (ITO), indium zinc oxide (IZO), aluminum tin oxide (ATO), aluminum zinc oxide (AZO), indium gallium zinc oxide (IGZO), or transparent conductive materials such as metals or alloys having a thickness less than 60 angstroms.

The driving circuit layer 130 includes a gate layer 131, a gate insulating layer 132, an active layer 133, a source-drain layer 134, and a passivation layer 135, which are stacked from top to bottom. The gate layer 131 is patterned to form a gate of a thin film transistor. Material of the gate layer 131 can be metal molybdenum, aluminum, copper, titanium, chromium, or silver, or a combination thereof. The gate layer 131 can be can be a single-film layer structure, such as single-layer metal copper, single-layer metal aluminum, or single-layer metal copper, etc.; it can be a double-layer structure, such as aluminum/molybdenum laminated structure, aluminum/titanium laminated structure, or copper/titanium laminated structure; it can also be a three-layer structure, such as molybdenum/aluminum/molybdenum laminated structure, titanium/aluminum/titanium laminated structure, or titanium/copper/titanium laminated structure, etc., which are not particularly limited herein. Material of the gate insulating layer 132 includes an inorganic material, an organic material, or other suitable materials. The inorganic material includes, but is not limited to, silicon oxide, silicon nitride, or silicon oxynitride. The organic material includes, but is not limited to, polyimide resin, epoxy resin, acrylic resin or tetrafluoroethylene-perfluoroalkoxy vinyl ether copolymer. The active layer 133 is patterned to form a channel of the thin film transistor. Material of the active layer 133 can be an oxide semiconductor material, such as indium gallium zinc oxide, indium tin oxide, indium zinc oxide, etc., or a polycrystalline silicon material or single crystal silicon material. The source-drain layer 134 is patterned to form a source and a drain of the thin film transistor. Material of the source-drain layer 134 is similar to the material of the gate layer 131. Material of the passivation layer 135 is similar to the material of the gate insulating layer.

The pixel electrode layer 140 is patterned to form a pixel electrode. The pixel electrode layer 140 is a transparent conductive film layer. Material of the pixel electrode layer 140 includes indium tin oxide, indium zinc oxide, aluminum tin oxide, aluminum zinc oxide, indium gallium zinc oxide, or transparent conductive materials such as metals or alloys having a thickness less than 60 angstroms.

The insulating layer 150 is used to isolate the touch electrode layer 120 and the driving circuit layer 130. Material of the insulating layer 150 includes an inorganic material, an organic material, or other suitable materials. The inorganic material includes, but is not limited to, silicon oxide, silicon nitride, or silicon oxynitride. The organic material includes, but is not limited to, polyimide resin, epoxy resin, acrylic resin or tetrafluoroethylene-perfluoroalkoxy vinyl ether copolymer.

A second substrate 200 includes a second base 210, a common electrode layer 220, a black matrix layer 230, and a color resist layer 240. The black matrix layer 230 and the color resist layer 240 are disposed on a same layer, and both are disposed on the second base 210 and are bonded to the second base 210. The common electrode layer 220 is disposed on the black matrix layer 230 and the color resist layer 240, and covers the black matrix layer 230 and the color resist layer 240.

The second base 210 is a transparent base, and is generally a transparent rigid glass base, or a transparent flexible base. The transparent flexible base generally includes a first organic base, a second organic base, and an inorganic base between the first organic base and the second organic base. Materials of the first organic base and the second organic base are usually organic polymer materials such as polyacetamide and polyethylene terephthalate. Material of the inorganic base is generally silicon oxide, which is used to block external particles from entering the substrate and to isolate water and oxygen.

The black matrix layer 230 is patterned to form a color resist region. Material of the black matrix layer 230 is generally carbon black acrylic resin or other materials that shield light. The black matrix layer 230 is mainly used to separate sub-pixels, prevent color mixing between the sub-pixels, and improve color purity of displayed image. Meanwhile, it prevents external light from irradiating onto the channel of the thin film transistor, which causes a risk of photo-generated electric leakage of the semiconductor active layer material.

The color resist layer 240 is formed in the color resist region of the black matrix layer 230 and is used to selectively transmit light entering the color resist layer 240, so that the display panel displays different colors.

The common electrode layer 220 is disposed on an entire surface of the black matrix layer 230 and the color resist layer 240. The common electrode layer 220 is a transparent conductive film layer. Material of the common electrode layer 220 includes indium tin oxide, indium zinc oxide, aluminum tin oxide, aluminum zinc oxide, indium gallium zinc oxide, or transparent conductive materials such as metals or alloys having a thickness less than 60 angstroms.

In the present embodiment, the touch electrode layer and the driving circuit layer are simultaneously disposed on the first substrate, which realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

In a second embodiment, please refer to FIG. 2, which is a schematic diagram of a second structure of the self-capacitive touch display panel according to an embodiment of the present application. The self-capacitive touch display panel provided in the present embodiment includes as follows.

A first substrate 100 includes a first base 110, a touch electrode layer 120, a driving circuit layer 130, a pixel electrode layer 140, and an insulating layer 150. The touch electrode layer 120 is disposed under the first base 110, and is bonded to the first base 110. The driving circuit layer 130 is disposed under the touch electrode layer 120, and is separated from the touch electrode layer 120 by the insulating layer 150. The pixel electrode layer 140 is disposed under the driving circuit layer 130, and is electrically connected to the driving circuit layer 130 through a hole.

The first base 110, the touch electrode layer 120, the driving circuit layer 130, the pixel electrode layer 140, and the insulating layer 150 are similar to the first base 110, the driving circuit layer 130, the pixel electrode layer 140, and the insulating layer 150 in the first embodiment, respectively. For details, refer to the first embodiment, and details are not described herein again.

The touch electrode layer 120 includes a touch electrode terminal 121 and a touch electrode 122. The touch electrode terminal 121 and the touch electrode 122 are integrally formed, that is, the touch electrode terminal 121 and the touch electrode 122 are fabricated by a same process. Materials of the touch electrode terminal 121 and 122 are same. Materials of the touch electrode terminal 121 and the touch electrode 122 can be opaque materials, such as metal molybdenum, aluminum, copper, titanium, chromium, or silver, or a combination thereof, and can be a single-film layer structure, such as single-layer metal copper, single-layer metal aluminum, or single-layer metal copper, etc.; it can be a double-layer structure, such as aluminum/molybdenum laminated structure, aluminum/titanium laminated structure, or copper/titanium laminated structure; it can also be a three-layer structure, such as molybdenum/aluminum/molybdenum laminated structure, titanium/aluminum/titanium laminated structure, or titanium/copper/titanium laminated structure, etc. At this time, the touch electrode 122 has a grid structure to ensure an aperture ratio of the display panel. Materials of the touch electrode terminal 121 and the touch electrode 122 can also be transparent materials, such as indium tin oxide, indium zinc oxide, aluminum tin oxide, aluminum zinc oxide, indium gallium zinc oxide, or transparent conductive materials such as metals or alloys having a thickness less than 60 angstroms.

A second substrate 200 includes a second base 210, a common electrode layer 220, a black matrix layer 230, and a color resist layer 240. The second base 210, the common electrode layer 220, the black matrix layer 230, and the color resist layer 240 are similar to the second base 210, the common electrode layer 220, the black matrix layer 230, and the color resist layer 240 in the first embodiment, respectively. For details, refer to the first embodiment, and details are not described herein again.

Compared with the first embodiment, the touch electrode and the touch electrode terminal are integrally formed in the present embodiment, and fabricating process of the touch electrode and the touch electrode terminal is combined into a photolithography process, which simplifies fabrication process and reduces production costs. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

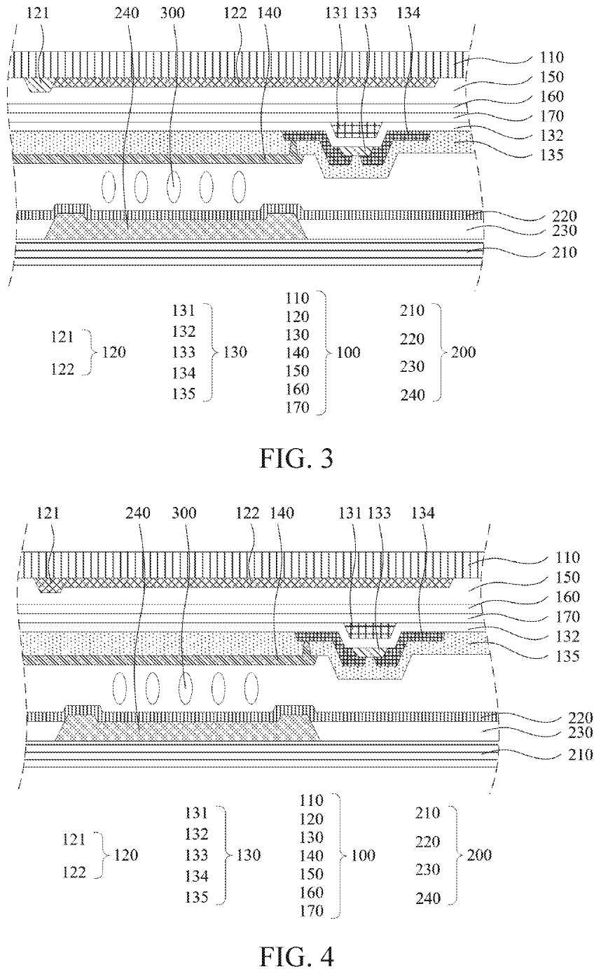

In a third embodiment, please refer to FIG. 3, which is a schematic diagram of a third structure of the self-capacitive touch display panel provided by an embodiment of the present application. The self-capacitive touch display panel provided in the present embodiment includes as follows.

A first substrate 100 includes a first base 110, a touch electrode layer 120, a driving circuit layer 130, a pixel electrode layer 140, a first insulating layer 150, a shielding layer 160, and a second insulating layer 170. The touch electrode layer 120 is disposed under the first base 110, and is bonded to the first base 110. The driving circuit layer 130 is disposed under the touch electrode layer 120, and is separated from the touch electrode layer 120 by the first insulating layer 150, the shielding layer 160, and the second insulating layer 170. The pixel electrode layer 140 is disposed under the driving circuit layer 130, and is electrically connected to the driving circuit layer 130 through a hole. The shielding layer 160 is separated from the touch electrode layer 120 by the first insulating layer 150, and is separated from the driving circuit layer 130 by the second insulating layer 170.

The first base 110, the driving circuit layer 130, the pixel electrode layer 140, and the first insulating layer 150 and the second insulating layer 170 are similar to the first base 110, the driving circuit layer 130, the pixel electrode layer 140, and the insulating layer 150 in the first embodiment, respectively. For details, refer to the first embodiment, and details are not described herein again.

The shielding layer 160 is disposed between the touch electrode layer 120 and the driving circuit layer 130, and is used to shield electromagnetic waves generated by the touch electrode layer 120 so as to prevent electromagnetic waves generated by the touch electrode layer 120 from propagating to the driving circuit layer 130 to prevent noise interference, and also is used to shield electromagnetic waves generated by the driving circuit layer 130 so as to prevent electromagnetic waves generated by the driving circuit layer 130 from propagating to the touch electrode layer 120 to prevent noise interference, enhancing independent propagation of signals in the touch electrode layer 120 and the driving circuit layer 130 and reducing interaction noise. The shielding layer 160 is a transparent conductive film layer, and material of the shielding layer 160 includes transparent conductive materials such as indium tin oxide, indium zinc oxide, aluminum tin oxide, aluminum zinc oxide, indium gallium zinc oxide, or transparent conductive materials such as metals or alloys having a thickness less than 60 angstroms.

A second substrate 200 includes a second base 210, a common electrode layer 220, a black matrix layer 230, and a color resist layer 240. The second base 210, the common electrode layer 220, the black matrix layer 230, and the color resist layer 240 are similar to the second base 210, the common electrode layer 220, the black matrix layer 230, and the color resist layer 240 in the first embodiment, respectively. For details, refer to the first embodiment, and details are not described herein again.

Compared with the first embodiment, the shielding layer is added between the touch electrode layer and the driving circuit layer to shield electromagnetic interference between the touch electrode layer and the driving circuit layer in the present embodiment, thereby enhancing independent propagation of signals in the touch electrode layer and the driving circuit layer and reducing interaction noise. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

In a fourth embodiment, please refer to FIG. 4, which is a schematic diagram of a fourth structure of the self-capacitive touch display panel according to an embodiment of the present application. The self-capacitive touch display panel provided in the present embodiment includes as follows.

A first substrate 100 includes a first base 110, a touch electrode layer 120, a driving circuit layer 130, a pixel electrode layer 140, a first insulating layer 150, a shielding layer 160, and a second insulating layer 170. The touch electrode layer 120 is disposed under the first base 110, and is bonded to the first base 110. The driving circuit layer 130 is disposed under the touch electrode layer 120, and is separated from the touch electrode layer 120 by the first insulating layer 150, the shielding layer 160, and the second insulating layer 170. The pixel electrode layer 140 is disposed under the driving circuit layer 130, and is electrically connected to the driving circuit layer 130 through a hole. The shielding layer 160 is separated from the touch electrode layer 120 by the first insulating layer 150, and is separated from the driving circuit layer 130 by the second insulating layer 170.

The first base 110, the touch electrode layer 120, the driving circuit layer 130, the pixel electrode layer 140, and the first insulating layer 150 and the second insulating layer 170 are similar to the first base 110, the driving circuit layer 130, the pixel electrode layer 140, and the insulating layer 150 in the second embodiment, respectively. For details, refer to the second embodiment, and details are not described herein again.

The shielding layer 160 is disposed between the touch electrode layer 120 and the driving circuit layer 130, and is used to shield electromagnetic waves generated by the touch electrode layer 120 so as to prevent electromagnetic waves generated by the touch electrode layer 120 from propagating to the driving circuit layer 130 to prevent noise interference, and also is used to shield electromagnetic waves generated by the driving circuit layer 130 so as to prevent electromagnetic waves generated by the driving circuit layer 130 from propagating to the touch electrode layer 120 to prevent noise interference, enhancing independent propagation of signals in the touch electrode layer 120 and the driving circuit layer 130 and reducing interaction noise. The shielding layer 160 is a transparent conductive film layer, and material of the shielding layer 160 includes transparent conductive materials such as indium tin oxide, indium zinc oxide, aluminum tin oxide, aluminum zinc oxide, indium gallium zinc oxide, or transparent conductive materials such as metals or alloys having a thickness less than 60 angstroms.

A second substrate 200 includes a second base 210, a common electrode layer 220, a black matrix layer 230, and a color resist layer 240. The second base 210, the common electrode layer 220, the black matrix layer 230, and the color resist layer 240 are similar to the second base 210, the common electrode layer 220, the black matrix layer 230, and the color resist layer 240 in the first embodiment, respectively. For details, refer to the first embodiment, and details are not described herein again.

Compared with the second embodiment, the shielding layer is added between the touch electrode layer and the driving circuit layer to shield electromagnetic interference between the touch electrode layer and the driving circuit layer in the present embodiment, thereby enhancing independent propagation of signals in the touch electrode layer and the driving circuit layer and reducing interaction noise. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

In a fifth embodiment, please refer to FIG. 5, which is a schematic diagram of a fifth structure of the self-capacitive touch display panel according to an embodiment of the present application. The self-capacitive touch display panel provided in the present embodiment includes as follows.

A first substrate 100 includes a first base 110, a touch electrode layer 120, a driving circuit layer 130, a pixel electrode layer 140, and an insulating layer 150. The first base 110, the touch electrode layer 120, the driving circuit layer 130, the pixel electrode layer 140, and the insulating layer 150 are similar to the first base 110, the driving circuit layer 130, the pixel electrode layer 140, and the insulating layer 150 in the first embodiment, respectively. For details, refer to the first embodiment, and details are not described herein again.

The difference is that a projection of the touch electrode 122 on the first base 110 and a projection of the thin film transistor on the first base 110 are not overlapped, that is, the touch electrode 122 gives way to the thin film transistor in the driving circuit layer 130, which makes a formed substrate of the thin film transistor flatter, and ensures the electrical characteristics of the thin film transistor.

A second substrate 200 includes a second base 210, a common electrode layer 220, a black matrix layer 230, and a color resist layer 240. The second base 210, the common electrode layer 220, the black matrix layer 230, and the color resist layer 240 are similar to the second base 210, the common electrode layer 220, the black matrix layer 230, and the color resist layer 240 in the first embodiment, respectively. For details, refer to the first embodiment, and details are not described herein again.

Compared with the first embodiment, in the present embodiment, the touch electrode gives way to the thin film transistor in the driving circuit layer, which makes a formed substrate of the thin film transistor flatter, and ensures the electrical characteristics of the thin film transistor. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

In a sixth embodiment, a self-capacitive touch display panel provided in the present embodiment includes as follows.

A first substrate 100 includes a first base 110, a touch electrode layer 120, a driving circuit layer 130, a pixel electrode layer 140, and an insulating layer 150. The first base 110, the touch electrode layer 120, the driving circuit layer 130, the pixel electrode layer 140, and the insulating layer 150 are similar to the first base 110, the driving circuit layer 130, the pixel electrode layer 140, and the insulating layer 150 in the second embodiment, respectively. For details, refer to the second embodiment, and details are not described herein again.

The difference is that a projection of the touch electrode 122 on the first base 110 and a projection of the thin film transistor on the first base 110 are not overlapped, that is, the touch electrode 122 gives way to the thin film transistor in the driving circuit layer 130, which makes a formed substrate of the thin film transistor flatter, and ensures the electrical characteristics of the thin film transistor.

A second substrate 200 includes a second base 210, a common electrode layer 220, a black matrix layer 230, and a color resist layer 240. The second base 210, the common electrode layer 220, the black matrix layer 230, and the color resist layer 240 are similar to the second base 210, the common electrode layer 220, the black matrix layer 230, and the color resist layer 240 in the second embodiment, respectively. For details, refer to the second embodiment, and details are not described herein again.

Compared with the first embodiment, in the present embodiment, the touch electrode gives way to the thin film transistor in the driving circuit layer, which makes a formed substrate of the thin film transistor flatter, and ensures the electrical characteristics of the thin film transistor. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

In a seventh embodiment, a self-capacitive touch display panel provided in the present embodiment includes as follows.

A first substrate 100 includes a first base 110, a touch electrode layer 120, a driving circuit layer 130, a pixel electrode layer 140, a first insulating layer 150, a shielding layer 160, and a second insulating layer 170. The first base 110, the touch electrode layer 120, the driving circuit layer 130, the pixel electrode layer 140, the first insulating layer 150, the shielding layer 160, and the second insulating layer 170 are similar to the first base 110, the driving circuit layer 130, the pixel electrode layer 140, the first insulating layer 150, the shielding layer 160, and the second insulating layer 170 in the third embodiment, respectively. For details, refer to the third embodiment, and details are not described herein again.

The difference is that a projection of the touch electrode 122 on the first base 110 and a projection of the thin film transistor on the first base 110 are not overlapped, that is, the touch electrode 122 gives way to the thin film transistor in the driving circuit layer 130, which makes a formed substrate of the thin film transistor flatter, and ensures the electrical characteristics of the thin film transistor.

A second substrate 200 includes a second base 210, a common electrode layer 220, a black matrix layer 230, and a color resist layer 240. The second base 210, the common electrode layer 220, the black matrix layer 230, and the color resist layer 240 are similar to the second base 210, the common electrode layer 220, the black matrix layer 230, and the color resist layer 240 in the third embodiment, respectively. For details, refer to the third embodiment, and details are not described herein again.

Compared with the third embodiment, in the present embodiment, the touch electrode gives way to the thin film transistor in the driving circuit layer, which makes a formed substrate of the thin film transistor flatter, and ensures the electrical characteristics of the thin film transistor. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

In an eighth embodiment, a self-capacitive touch display panel provided in the present embodiment includes as follows.

A first base 110, a touch electrode layer 120, a driving circuit layer 130, a pixel electrode layer 140, a first insulating layer 150, a shielding layer 160, and a second insulating layer 170. The first base 110, the touch electrode layer 120, the driving circuit layer 130, the pixel electrode layer 140, the first insulating layer 150, the shielding layer 160, and the second insulating layer 170 are similar to the first base 110, the driving circuit layer 130, the pixel electrode layer 140, the first insulating layer 150, the shielding layer 160, and the second insulating layer 170 in the fourth embodiment, respectively. For details, refer to the fourth embodiment, and details are not described herein again.

The difference is that a projection of the touch electrode 122 on the first base 110 and a projection of the thin film transistor on the first base 110 are not overlapped, that is, the touch electrode 122 gives way to the thin film transistor in the driving circuit layer 130, which makes a formed substrate of the thin film transistor flatter, and ensures the electrical characteristics of the thin film transistor.

A second substrate 200 includes a second base 210, a common electrode layer 220, a black matrix layer 230, and a color resist layer 240. The second base 210, the common electrode layer 220, the black matrix layer 230, and the color resist layer 240 are similar to the second base 210, the common electrode layer 220, the black matrix layer 230, and the color resist layer 240 in the fourth embodiment, respectively. For details, refer to the fourth embodiment, and details are not described herein again.

Compared with the fourth embodiment, in the present embodiment, the touch electrode gives way to the thin film transistor in the driving circuit layer, which makes a formed substrate of the thin film transistor flatter, and ensures the electrical characteristics of the thin film transistor. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

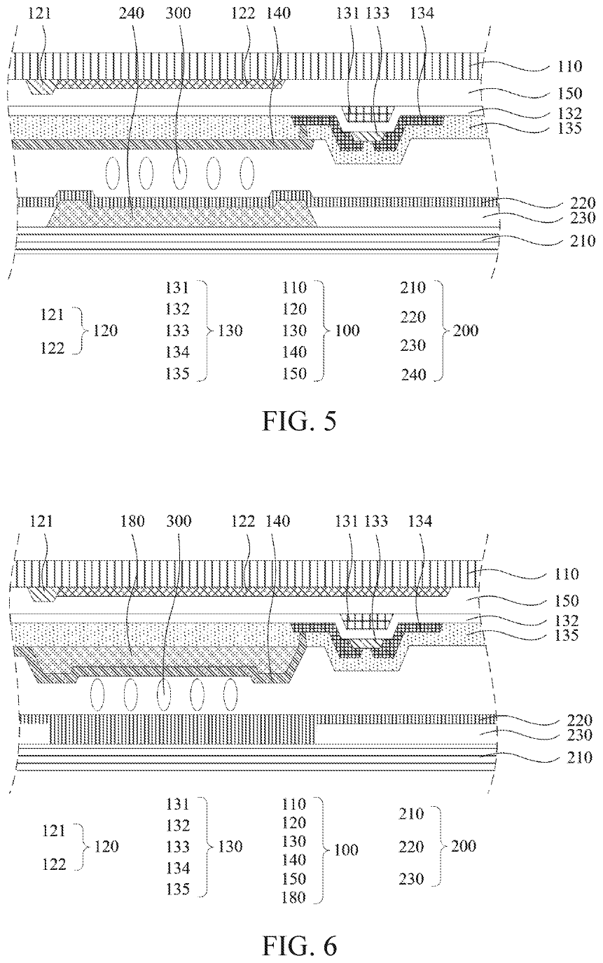

In a ninth embodiment, please refer to FIG. 6, which is a schematic diagram of a sixth structure of the self-capacitive touch display panel according to an embodiment of the present application. The self-capacitive touch display panel provided in the present embodiment includes as follows.

A first substrate 100 includes a first base 110, a touch electrode layer 120, a driving circuit layer 130, a pixel electrode layer 140, an insulating layer 150, and a color resist layer 180. The first base 110, the touch electrode layer 120, the driving circuit layer 130, the pixel electrode layer 140, and the insulating layer 150 are similar to the first base 110, the driving circuit layer 130, the pixel electrode layer 140, and the insulating layer 150 in the first embodiment, respectively. For details, refer to the first embodiment, and details are not described herein again.

A second substrate 200 includes a second base 210, a common electrode layer 220, and a black matrix layer 230. The second base 210, the common electrode layer 220, and the black matrix layer 230 are similar to the second base 210, the common electrode layer 220, and the black matrix layer 230 in the first embodiment, respectively. For details, refer to the first embodiment, and details are not described herein again.

The difference is that the color resist layer 180 is disposed under the passivation layer 135 and the pixel electrode layer 140, the pixel electrode layer 140 covers the color resist layer 180, and a projection of the color resist layer 180 on the second base 210 and a projection of a color resist region of the black matrix layer 230 are overlapped. The color resist is disposed on the first substrate 100, so that a distance between the touch electrode and the pixel electrode is increased, a parasitic capacitance between the touch electrode and the pixel electrode can be further reduced, and also signal amount of display driving and touch driving can be increased.

Compared with the first embodiment, in the present embodiment, the color resist is disposed on the first substrate, so that a distance between the touch electrode and the pixel electrode is increased, a parasitic capacitance between the touch electrode and the pixel electrode can be further reduced, and also signal amount of display driving and touch driving can be increased. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

According to the ninth embodiment as shown in FIG. 6, in combination with the first to eighth embodiments described above, a further improvement of the color resist layer on the first substrate can be made as shown in the ninth embodiment, on the basis of the first to eighth embodiments, further reducing parasitic capacitance between the touch electrode and the pixel electrode, while improving signal amount of display driving and touch driving. For specific implementation, refer to the ninth embodiment, which is not described in detail here.

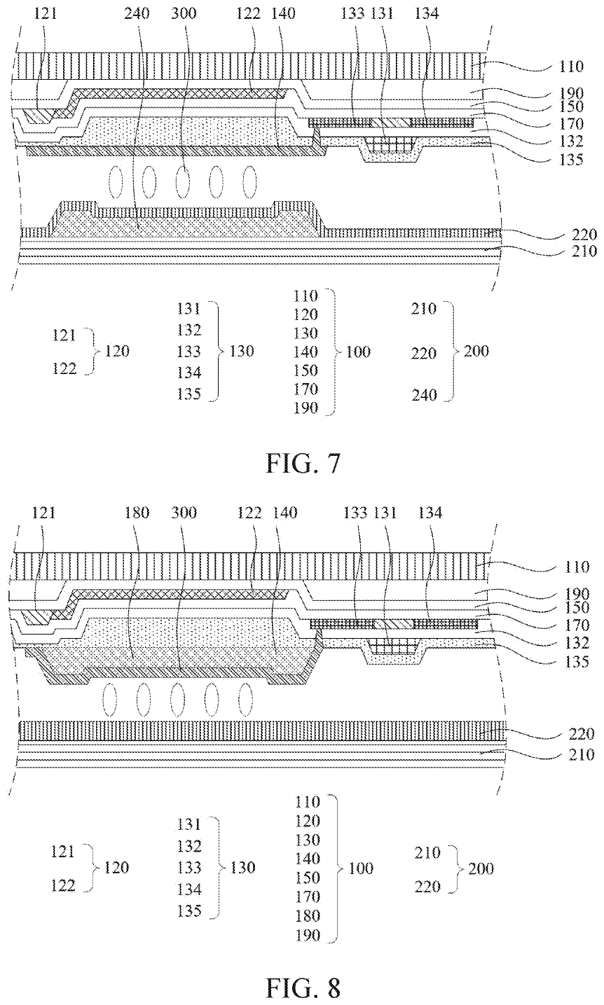

In a tenth embodiment, please refer to FIG. 7, which is a schematic diagram of a seventh structure of the self-capacitive touch display panel according to an embodiment of the present application. The self-capacitive touch display panel provided in the present embodiment includes as follows.

A first substrate 100 includes a first base 110, a touch electrode layer 120, a driving circuit layer 130, a pixel electrode layer 140, a first insulating layer 150, a second insulating layer 170, and a black matrix layer 190. The first base 110, the touch electrode layer 120, the driving circuit layer 130, the pixel electrode layer 140, the first insulating layer 150, and the second insulating layer 170 are similar to the first base 110, the touch electrode layer 120, the driving circuit layer 130, the pixel electrode layer 140, the first insulating layer 150, and the second insulating layer 170 in the fifth embodiment, respectively. For details, refer to the fifth embodiment, and details are not described herein again.

A second substrate 200 includes a second base 210, a common electrode layer 220, and a color resist layer 240. The second base 210, the common electrode layer 220, and the color resist layer 240 are similar to the second base 210, the common electrode layer 220, and the color resist layer 240 of the second substrate 200 in the fifth embodiment, respectively. For details, reference can be made to the fifth embodiment, and details are not described herein again.

The difference is that the black matrix layer 190 is disposed under the first base 110 and is bonded to the first base 110, the touch electrode layer 120 is disposed under the black matrix layer 190 and is separated by the first insulating layer 150, a projection of the color resist layer 180 on the first base 110 is overlapped with a projection of a color resist region of the black matrix layer 230 on the first base 110, and a thin film transistor in the driving circuit layer 130 is changed from a top gate structure to a bottom gate structure. Placing the black matrix layer 190 on the first substrate 100 is beneficial to further reducing influence of light reflected by metal material.

Compared with the fifth embodiment, in the present embodiment, the black matrix layer is disposed on the first substrate, which is beneficial to further reduce influence of light reflected by metal material. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

According to the tenth embodiment as shown in FIG. 7, in combination with the fifth to eighth embodiments described above, the black matrix layer can be disposed on the first substrate as shown in the tenth embodiment, on the basis of the fifth to eighth embodiments, which is beneficial to further reduce influence of light reflected by metal material. For specific implementation, refer to the tenth embodiment, which is not described in detail here.

In an eleventh embodiment, please refer to FIG. 8, which is a schematic diagram of an eighth structure of the self-capacitive touch display panel according to an embodiment of the present application. The self-capacitive touch display panel provided in the present embodiment includes as follows.

A first substrate 100 includes a first base 110, a touch electrode layer 120, a driving circuit layer 130, a pixel electrode layer 140, a first insulating layer 150, a second insulating layer 170, a color resist layer 180, and a black matrix layer 190. The first base 110, the touch electrode layer 120, the driving circuit layer 130, the pixel electrode layer 140, the first insulating layer 150, and the second insulating layer 170 are similar to the first base 110, the touch electrode layer 120, the driving circuit layer 130, the pixel electrode layer 140, the first insulating layer 150, and the second insulating layer 170 in the fifth embodiment, respectively. For details, reference can be made to the fifth embodiment, and details are not described herein again.

A second substrate 200 includes a second base 210 and a common electrode layer 220. The second base 210 and the common electrode layer 220 are similar to the second base 210 and the common electrode layer 220 in the fifth embodiment. For details, refer to the fifth embodiment, and details are not described herein again.

The difference is that the color resist layer 180 is disposed under the passivation layer 135 and the pixel electrode layer 140, and the pixel electrode layer 140 covers the color resist layer 180. The color resist is disposed on the first substrate 100, so that a distance between the touch electrode and the pixel electrode is increased, a parasitic capacitance between the touch electrode and the pixel electrode can be further reduced, and also signal amount of display driving and touch driving can be increased. The black matrix layer 190 is disposed under the first base 110 and is bonded to the first base 110, the touch electrode layer 120 is disposed under the black matrix layer 190 and is separated by the first insulating layer 150, and a projection of the color resist layer 180 on the first base 110 is overlapped with a projection of a color resist region of the black matrix layer 230 on the first base 110. Placing the black matrix layer 190 on the first substrate 100 is beneficial to further reducing influence of light reflected by metal material. A thin film transistor in the driving circuit layer 130 is changed from a top gate structure to a bottom gate structure.

Compared with the fifth embodiment, in the present embodiment, both the black matrix layer and the color resist layer are disposed on the first substrate, a parasitic capacitance between the touch electrode and the pixel electrode can be further reduced, and also signal amount of display driving and touch driving can be increased, which is beneficial to further reduce influence of light reflected by metal material. Meanwhile, the self-capacitive touch display panel provided in the present embodiment also realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

According to the eleventh embodiment shown in FIG. 8, in combination with the fifth to eighth embodiments described above, both the black matrix layer and the color resist layer can be disposed on the first substrate as shown in the eleventh embodiment, on the basis of the fifth to eighth embodiments, which can further reduce parasitic capacitance between the touch electrode and the pixel electrode, and also increase signal amount of display driving and touch driving. It is beneficial to further reduce influence of light reflected by metal material. For specific implementation, refer to the eleventh embodiment, which is not described in detail here.

An embodiment of the present application further provides a display device. The display device includes a self-capacitive touch display panel, and the self-capacitive touch display panel includes as follows.

A first substrate includes a first base, a touch electrode layer, a driving circuit layer, and a pixel electrode layer. The touch electrode layer is disposed on a side of the first base near the driving circuit layer, the driving circuit layer is disposed on a side of the touch electrode layer away from the first base, and the pixel electrode layer is disposed on a side of the driving circuit layer away from the first base.

A second substrate is disposed opposite to the first substrate, which includes a second base and a common electrode layer.

A liquid crystal layer is filled between the first substrate and the second substrate.

In an embodiment, a thin film transistor is formed in the driving circuit layer, the touch electrode layer includes a touch electrode, and a projection of the thin film transistor on the first base at least partially overlaps a projection of the touch electrode on the first base.

In an embodiment, a thin film transistor is formed in the driving circuit layer, the touch electrode layer includes a touch electrode, and a projection of the thin film transistor on the first base and a projection of the touch electrode on the first base are not overlapped.

In an embodiment, the first substrate further includes a black matrix layer, the black matrix layer is disposed on a side of the first base near the touch electrode layer and is in contact with the first base, and the second substrate further includes a color resist layer.

In an embodiment, the first substrate further includes a color resist layer, the color resist layer is disposed on a side of the pixel electrode layer near the first base and is in contact with the pixel electrode layer, and the second substrate further includes a black matrix layer.

In an embodiment, the first substrate further includes a black matrix layer and a color resist layer, the black matrix layer is disposed on a side of the first base near the touch electrode layer and is in contact with the first base, and the color resist layer is disposed on a side of the pixel electrode layer near the first base and is in contact with the pixel electrode layer.

In an embodiment, the touch electrode layer includes a touch electrode terminal and a touch electrode, and the touch electrode terminal is connected to the touch electrode.

In an embodiment, the touch electrode terminal and the touch electrode are integrally formed, and the touch electrode has a grid structure.

In an embodiment, the touch electrode terminal and the touch electrode are formed separately, and the touch electrode is a planar film structure.

In an embodiment, the first substrate further includes a shielding layer, and the shielding layer is disposed between the touch electrode layer and the driving circuit layer.

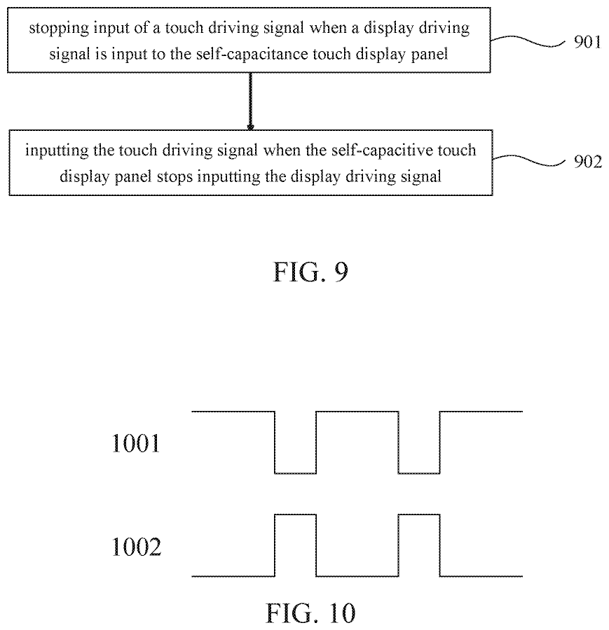

Meanwhile, an embodiment of the present application also provides a driving method of a self-capacitive touch display panel, which is used to drive the self-capacitive touch display panels described above. As shown in FIG. 9, the driving method includes:

step 901, stopping input of a touch driving signal when a display driving signal is input to the self-capacitance touch display panel; and

step 902, inputting the touch driving signal when the self-capacitive touch display panel stops inputting the display driving signal.

Please refer to FIG. 10, which is a driving timing diagram of the self-capacitive touch display panel according to an embodiment of the present application. In a time frame, when the display driving signal 1001 is input to the display panel, the touch driving signal 1002 is stopped; when the display driving signal 1001 is stopped input to the display panel, the touch driving signal 1002 is input.

The present embodiment provides a driving method of a self-capacitive touch display panel. This method realizes a synchronous driving method of display driving and touch driving. By separating a driving time of a display and a touch of the display panel, mutual interference between electrical signals during a display phase and a touch phase of the display panel is reduced, which enhances display performance of the display panel in the display phase and touch performance of the display panel in the touch phase.

According to the embodiments described above, it can be known as follows.

Embodiments of the present application provide a self-capacitive touch display panel, a driving method thereof, and a display device. The self-capacitive touch display panel includes a first substrate including a first base, a touch electrode layer, a driving circuit layer, and a pixel electrode layer, wherein the touch electrode layer is disposed on a side of the first base near the driving circuit layer, the driving circuit layer is disposed on a side of the touch electrode layer away from the first base, and the pixel electrode layer is disposed on a side of the driving circuit layer away from the first base; a second substrate disposed opposite to the first substrate, including a second base and a common electrode layer; and a liquid crystal layer filled between the first substrate and the second substrate. The display panel realizes integration of touch display by providing the touch electrode layer in the first substrate, and realizes integration of a vertically-oriented display panel and a self-capacitive touch scheme. There are almost no increase to thickness and weight of the self-capacitive touch display panel, and a frame region increases slightly. Compared with an externally mounted touch display panel, a tempered protective glass and a lamination process are further omitted, which greatly saves costs. Compared with a traditional in-cell touch display panel, it breaks through limitation that in-cell touch electrodes can only be used in a common electrode multiplexing method, and solves technical difficulties of bridging large touch circuits across different substrates. Compared with a mutual capacitance touch display panel, the present self-capacitive touch display panel has higher sensitivity, and is more suitable for large-scale commercial products.

Embodiments of the present invention have been described, but not intended to impose any unduly constraint to the appended claims. For a person skilled in the art, any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A self-capacitive touch display panel, comprising:
a first substrate comprising a first base, a touch electrode layer, a driving circuit layer, and a pixel electrode layer, wherein the touch electrode layer is disposed on a side of the first base near the driving circuit layer, the driving circuit layer is disposed on a side of the touch electrode layer away from the first base, and the pixel electrode layer is disposed on a side of the driving circuit layer away from the first base;
a second substrate disposed opposite to the first substrate, and comprising a second base and a common electrode layer; and
a liquid crystal layer filled between the first substrate and the second substrate.

2. The self-capacitive touch display panel according to claim 1, further comprising a thin film transistor formed in the driving circuit layer, wherein the touch electrode layer comprises a touch electrode, and a projection of the thin film transistor on the first base at least partially overlaps a projection of the touch electrode on the first base.

3. The self-capacitive touch display panel according to claim 1, further comprising a thin film transistor formed in the driving circuit layer, wherein the touch electrode layer comprises a touch electrode, and a projection of the thin film transistor on the first base does not overlap a projection of the touch electrode on the first base.

4. The self-capacitive touch display panel according to claim 1, wherein the first substrate further comprises a black matrix layer, the black matrix layer is disposed on a side of the first base near the touch electrode layer and is in contact with the first base, and the second substrate further comprises a color resist layer.

5. The self-capacitive touch display panel according to claim 1, wherein the first substrate further comprises a color resist layer, the color resist layer is disposed on a side of the pixel electrode layer near the first base and is in contact with the pixel electrode layer, and the second substrate further comprises a black matrix layer.

6. The self-capacitive touch display panel according to claim 1, wherein the first substrate further comprises a black matrix layer and a color resist layer, the black matrix layer is disposed on a side of the first base near the touch electrode layer and is in contact with the first base, and the color resist layer is disposed on a side of the pixel electrode layer near the first base and is in contact with the pixel electrode layer.

7. The self-capacitive touch display panel according to claim 1, wherein the touch electrode layer comprises a touch electrode terminal and a touch electrode, and the touch electrode terminal is connected to the touch electrode.

8. The self-capacitive touch display panel according to claim 7, wherein the touch electrode terminal and the touch electrode are integrally formed, and the touch electrode has a grid structure.

9. The self-capacitance touch display panel according to claim 7, wherein the touch electrode terminal and the touch electrode are formed separately, and the touch electrode has a planar film structure.

10. The self-capacitive touch display panel according to claim 1, wherein the first substrate further comprises a shielding layer, and the shielding layer is disposed between the touch electrode layer and the driving circuit layer.

11. A display device comprising a self-capacitive touch display panel, wherein the self-capacitive touch display panel comprises:
a first substrate comprising a first base, a touch electrode layer, a driving circuit layer, and a pixel electrode layer, wherein the touch electrode layer is disposed on a side of the first base near the driving circuit layer, the driving circuit layer is disposed on a side of the touch electrode layer away from the first base, and the pixel electrode layer is disposed on a side of the driving circuit layer away from the first base;
a second substrate disposed opposite to the first substrate, and comprising a second base and a common electrode layer; and
a liquid crystal layer filled between the first substrate and the second substrate.

12. The display device according to claim 11, further comprising a thin film transistor formed in the driving circuit layer, wherein the touch electrode layer comprises a touch electrode, and a projection of the thin film transistor on the first base at least partially overlaps a projection of the touch electrode on the first base.

13. The display device according to claim 11, further comprising a thin film transistor formed in the driving circuit layer, wherein the touch electrode layer comprises a touch electrode, and a projection of the thin film transistor on the first base does not overlap a projection of the touch electrode on the first base.

14. The display device according to claim 11, wherein the first substrate further comprises a black matrix layer, the black matrix layer is disposed on a side of the first base near the touch electrode layer and is in contact with the first base, and the second substrate further comprises a color resist layer.

15. The display device according to claim 11, wherein the first substrate further comprises a color resist layer, the color resist layer is disposed on a side of the pixel electrode layer near the first base and is in contact with the pixel electrode layer, and the second substrate further comprises a black matrix layer.

16. The display device according to claim 11, wherein the first substrate further comprises a black matrix layer and a color resist layer, the black matrix layer is disposed on a side of the first base near the touch electrode layer and is in contact with the first base, and the color resist layer is disposed on a side of the pixel electrode layer near the first base and is in contact with the pixel electrode layer.

17. The display device according to claim 11, wherein the touch electrode layer comprises a touch electrode terminal and a touch electrode, and the touch electrode terminal is connected to the touch electrode.

18. The display device according to claim 17, wherein the touch electrode terminal and the touch electrode are integrally formed, and the touch electrode has a grid structure.

19. The display device according to claim 11, wherein the first substrate further comprises a shielding layer, and the shielding layer is disposed between the touch electrode layer and the driving circuit layer.

20. A driving method of the self-capacitive touch display panel of the claim 1, wherein the method comprises:
stopping input of a touch driving signal when a display driving signal is input to the self-capacitance touch display panel; and
inputting the touch driving signal when the self-capacitive touch display panel stops inputting the display driving signal.
